(19) United States
(12) Patent Application Publication
(10) Pub. No.: US 2025/0060736 A1
(43) Pub. Date: Feb. 20, 2025

(54) METHOD AND APPARATUS FOR MODELING DIGITAL MODEL OF A PRODUCTION SYSTEM

(71) Applicants: China ENFI Engineering Corporation, Beijing (CN); China Nonferrous Engineering Co., Ltd., Beijing (CN)

(72) Inventors: Chu Jinwang, Beijing (VN); Liu Cheng, Beijing (CN); Li Bing, Beijing (CN); Sun Ninglei, Beijing (CN); Chao Hexiang, Beijing (CN)

(73) Assignees: China ENFI Engineering Corporation, Beijing (CN); China Nonferrous Engineering Co., Ltd., Beijing (CN)

(21) Appl. No.: 18/652,761

(22) Filed: May 1, 2024

(30) Foreign Application Priority Data
Aug. 14, 2023 (CN) 202311014824.X
Aug. 14, 2023 (CN) 202311014827.3

(51) Int. Cl. G05B 19/418

(52) U.S. Cl. CPC G05B 19/41885

(57) ABSTRACT

The present disclosure provides a method and an apparatus for modeling a digital model of a production system, wherein the method comprises: dividing a process flow of the production system according to the process to obtain a plurality of process units to be constructed and link units; determining the process relationship between the process units, and constructing a digital model architecture, a flow model and an environment model; and constructing a digital model corresponding to the system flow according to the digital model architecture, the flow model and the external environment. With the solution of the present disclosure, it is able to realize the modeling of the process flow for complex production systems and improve the process control efficiency of the production system.

### CROSS-REFERENCE TO RELATED APPLICATIONS

The application claims priority to Chinese patent application No. 202311014827.3 and No. 202311014824.X, filed on Aug. 14, 2023, the entire contents of which are incorporated herein by reference.

### TECHNICAL FIELD

The present disclosure belongs to the technical field of production system flow control, and particularly relates to a method and an apparatus for modeling a digital model of a production system.

### BACKGROUND

For a production system, optimizing the system flow is a key to improve the production efficiency.

For example, in nonferrous metallurgy research and design, there are more research on basic metallurgy at the microscopic level (molecular, atomic, and ionic micro scale) and specialized metallurgical processes at the mesoscopic level (process and apparatus aspects), while there are less work on nonferrous metallurgical process research at the macroscopic level, and insufficient process research on production systems with complex nonferrous metallurgical processes, resulting in the previous and subsequent process units can not cooperate and continuously run, redundant coefficients of the process units are superposed, there are many bottlenecks and the system is in a chaotic state, which often leads to the failure of normal production, failure to reach the capacity, and even investment failure. Currently, metallurgical process simulation methods are very simple and generally include only substance flow, information flow and the like, and cannot simulate complex production systems.

In addition, the manufacturing industry may be divided into two parts, namely a discrete industry and a process industry, according to different production modes and product characteristics. The process industry mainly relates to the industries of chemical industry, metallurgy, petrifaction, papermaking, electric electricity and the like. The production process of the process industry is characterized in that: the flow and conversion of substance and energy, including physical changes, chemical changes, and changes in state, composition, properties and the like, occur within the spatio-temporal boundaries of the manufacturing process. Due to the complex production process of the process industry and many technological parameters, it is difficult to carry out the system flow design and simulate the actual production, it may lead to problems such as failure to reach the capacity or waste of resources.

### SUMMARY

In view of the above problems, the present disclosure provides a method and an apparatus for modeling a digital model of a production system, so as to overcome or at least partly solve the above problem.

In order to achieve the above objects, the following technical solutions are provided according to the present disclosure.

The present disclosure provides a method for modeling a digital model of a production system, comprising:
dividing a process flow of the production system according to the process to obtain a plurality of process units to be constructed;
determining the process relationship between the process units, and constructing a digital model architecture, a flow model and an environment model; and
constructing a digital model corresponding to the system flow according to the digital model architecture, the flow model and the external environment.

Further, the determining a process relationship between the process units, and constructing a digital model architecture, a flow model and an environment model comprises:
constructing a device group model corresponding to each process unit respectively, wherein the device group model comprises at least one agent, and the agents are connected in series or in parallel with each other;
constructing a flow model corresponding to each process unit respectively, wherein the flow model configures obtained flow data for the process unit, and the flow data comprises inlet flow data and/or outlet flow data, and the data types in the flow data at least comprise one or more of substance flow data, energy flow data, value flow data and information flow data; and
constructing an environment model corresponding to each process unit respectively, wherein the environment model configures obtained environment data for the process unit, and the data types of the environment data comprise one or more of water supply data, heat supply data, electricity supply data, steam supply data, material data, energy data and kinetic energy supply data.

Further, before constructing the digital model, the method further comprises:
according to the function of the process unit to be constructed, determining a plurality of chemical reaction equations for realizing the function, and constructing a reaction set model corresponding to the process unit;
constructing a process unit field model, wherein the process unit field model is reaction parameter information for realizing the chemical reaction equations in the reaction set, and the reaction parameter information includes one or more of storage volume information, temperature information, pressure information, pH information, substance information, concentration information, viscosity information, flow field rate information and gradient information.

Further, before constructing the digital model, the method further comprises:
analyzing the reaction parameter information by applying a preset factor analysis method, and determining target reaction parameter information and a value range corresponding to the target reaction parameter information;
constructing a system state function corresponding to the current process unit by taking the target reaction parameter information as a system state variable;
determining a plurality of parameter values corresponding to each system state variable respectively in each value range; and
matching the parameter values to construct a system state set model meeting a preset design requirement.

Further, before constructing the digital model, the method further comprises:
constructing a process unit fault set model, wherein the process unit fault set model configures fault information of each functional device and each pipeline for the process unit, wherein the fault information comprises the fault type and maintenance information corresponding to the fault type;
the maintenance information comprises one or more of shutdown frequency information, distribution pattern information and maintenance time information.

Further, before constructing the digital model, the method further comprises:
constructing a process unit clock model, wherein the process unit clock model configures time domain information and tempo time information for the process unit;
the time domain information is the time experienced by each flow data from the starting point of entering the process unit to the end point of exiting the process unit;
the tempo time information is duration corresponding to a basic action in a chemical reaction process for realizing the function, wherein the basic action is one or more of a predetermined amount of chemical reaction, a predetermined amount of separation of substance flow, leaching of a predetermined amount of substance flow.

Further, the determining a process relationship between the process units comprises:
defining a system flow chart, wherein the system flow chart comprises function charts and a flow sequence between the function charts;
analyzing the system flow chart into a plurality of processes and forming the plurality of processes into a system process flow chart;
configuring a device for realizing process functions according to the process functions and process capacities; and
constructing the device as an agent, and constructing a process unit according to the agent, and determining a process relationship of the process unit.

Further, after constructing the digital model, the method further comprises:
simulating, verifying and reconstructing the system flow through the digital model to optimize the system flow.

Further, the analyzing the system flow chart into a plurality of processes and forming the plurality of processes into a system process flow chart comprises:
analyzing each function chart into a plurality of processes and a process sequence between the processes; and
forming the plurality of the processes into a system process flow chart according to the flow sequence and the process sequence.

Further, the constructing a digital model architecture, a flow model and an environment model comprises:
structuring an interaction and a cooperation relationship between the process units and integrally constructing a link unit;
constructing a digital model architecture according to the system process flow chart by using the process unit and the link unit, and constructing a flow model and an external environment, wherein the external environment comprises water, electricity, steam and materials; and
constructing a digital model corresponding to the system flow according to the digital model architecture, the flow model and the external environment.

Further, the constructing a flow model comprises:
constructing a substance flow model;
constructing an energy flow model and a value flow model according to the substance flow model; and
constructing an information flow model according to the substance flow model, the energy flow model and the value flow model.

Further, the simulating, verifying and reconstructing the system flow through the digital model comprises:
importing data to the digital model, and performing a simulated operation of the digital model, wherein the data comprises at least one of design data, test data and reference measured data;
comparing actual productivity of the simulated operation with required productivity, determining whether the digital model is verified, and determining an optimization solution if the digital model is not verified; and
reconstructing the digital model by using the optimization solution until the digital model is verified.

Further, the determining whether the digital model is verified, and determining an optimization solution if the digital model is not verified comprises:
if the actual productivity is different from the required productivity and is not within a preset error range, identifying a system problem;
if the system problem is a system local index amplification superposition problem or a system local bottleneck restriction problem, taking out a problem process, and reconfiguring the problem process, or taking out a problem device, and reconfiguring the problem device, to update the digital model, and performing a re-simulated operation of the digital model until the difference between the actual productivity and the required productivity is within the preset error range.

Further, it also comprises:
if the system problem is the whole system productivity problem, redesigning the system flow and/or reconstructing the system structure again.

The present disclosure provides an apparatus for modeling a digital model of a production system, comprising:
a process unit constructing unit, configured to divide a process flow of the production system according to the process to obtain a plurality of process units to be constructed;
a model preliminary constructing unit, configured to determine a process relationship between the process units, and constructing a digital model architecture, a flow model and an environment model; and
a digital model constructing unit, configured to construct a digital model corresponding to the system flow according to the digital model architecture, the flow model and the external environment.

Further, the model preliminary constructing unit comprises:
a device group model constructing module, configured to construct a device group model corresponding to each process unit respectively, where the device group model includes at least one agent, and the agents are connected in series or in parallel with each other;
a flow model constructing module, configured to construct a flow model corresponding to each process unit respectively, wherein the flow model configures obtained flow data for the process unit, and the flow data comprises inlet flow data and/or outlet flow data, and the data types in the flow data at least comprise one or more of substance flow data, energy flow data, value flow data and information flow data; and
an environment model constructing module, configured to construct an environment model corresponding to each process unit respectively, wherein the environment model configures obtained environment data for the process unit, and the data types of the environment data comprise one or more of water supply data, heat supply data, electricity supply data, steam supply data, material data, energy data and kinetic energy supply data.

Further, the model preliminary constructing unit comprise:
a system flow definition module, configured to define a system flow chart, wherein the system flow chart comprises function charts and a flow sequence between the function charts;
a process flow chart determining module, configured to analyze the system flow chart into a plurality of processes and form the plurality of processes into a system process flow chart;
a device configuration module, configured to configure a device for realizing process functions according to the process functions and process capacities; and
a process unit determining module, configured to construct the device as an agent, construct a process unit according to the agent and determine a process relationship of the process unit.

Further, the apparatus also comprises:
a model optimization unit, configured to simulate, verify and reconstruct the system flow through the digital model to optimize the system flow.

Further, the process flow chart determining module is specifically configured to: analyze each function chart into a plurality of processes and a process sequence between the processes; and form the plurality of the processes into a system process flow chart according to the flow sequence and the process sequence.

Further, the model preliminary constructing unit comprises:
a link unit integration module, configured to structure an interaction and a cooperation relationship between the process units and integrally construct a link unit;
a model preliminary constructing module, configured to construct a digital model architecture according to the system process flow chart by using the process unit and the link unit, and construct a flow model and an external environment, wherein the external environment comprises water, electricity, steam and materials; and
a digital model constructing module, configured to construct a digital model corresponding to the system flow according to the digital model architecture, the flow model and the external environment.

Advantages and beneficial effects of the present disclosure are described as follows.

The method for modeling the digital model of the production system provided by the present disclosure divides a process flow of the production system according to the process to obtain a plurality of process units to be constructed; determines a process relationship between the process units, and constructs a digital model architecture, a flow model and an environment model, and constructs a digital model corresponding to the system flow according to the digital model architecture, the flow model and the external environment. So as to model the process flow of a complex production system, and improve the flow control efficiency of the production system.

In the method for modeling the process unit specifically provided by the present disclosure, a plurality of process units to be constructed are obtained by dividing a process flow according to the process; a device group model is constructed corresponding to each process unit respectively, wherein the device group model comprises at least one agent device, and the agent devices are connected in series or in parallel with each other; a flow data configuration model is constructed, wherein the flow data configuration model configures obtained flow data for the process unit, and the flow data comprises inlet flow data and/or outlet flow data, and the data types in the flow data at least comprise one or more of substance flow data, energy flow data, value flow data and information flow data; and an environment data configuration model is constructed, wherein the environment data configuration model configures obtained environment data for the process unit, and the data types of the environment data comprise one or more of water supply data, heat supply data, electricity supply data, steam supply data, material data, energy data and kinetic energy supply data. The modeling of the process unit is completed, and the digital model corresponding to the process unit is obtained. It can be seen that the construction of the digital model of the process unit is completed by constructing the device group model, by constructing the flow data configuration model, and by constructing the environment data configuration model. The modeling method in the present disclosure can model the process flow of a complex system, simplifying the construction process of the complex production system.

In the method for designing a complex system flow and modeling a digital model provided by the present disclosure, a system flow chart may be defined firstly, wherein the system flow chart comprises function charts and a flow sequence between the function charts; then, the system flow chart is analyzed into a plurality of processes, and the plurality of processes are form into a system process flow chart; further a device for realizing process functions is configured according to the process functions and process capacities; then, a digital model corresponding to the system flow is constructed according to the device and the system process flow chart; and finally, the system flow is simulated, verified and reconstructed through the digital model to optimize the system flow. Through the technical solutions of the present disclosure, the system flow chart is analyzed into a system process flow chart including a plurality of processes, and a device for realizing each process is configured, so that the system flow design is completed. In order to determine whether the actual production productivity is matched with the required productivity after the system flow design is put into production, a digital model corresponding to the system flow is constructed according to the device and the system process flow chart. the system flow is then simulated and verified by using the digital model so that the actual production is simulated. And when the actual productivity is not matched with the required productivity, a problem is identified to reconstruct and optimize the system flow.

### BRIEF DESCRIPTION OF DRAWINGS

By reading the detailed description of preferred embodiments below, various other advantages and benefits are clear to those skilled in the art. The drawings are only used for illustrating the preferred embodiments rather than limiting the present disclosure. Throughout the drawings, the same reference numerals are used to represent the same components. In the drawings:

FIG. 1 shows a flow chart of a method for modeling a digital model of a production system according to an embodiment of the present disclosure;

FIG. 2 shows a structural block diagram of an apparatus for modeling a digital model of a production system according to an embodiment of the present disclosure;

FIG. 3 shows a schematic flow chart of a method for modeling a process unit according to an embodiment of the present disclosure;

FIG. 4 shows a schematic flow chart of a method for modeling a process unit according to a further embodiment of the present disclosure;

FIG. 5 shows a flow chart of the process of laterite nickel ore hydrometallurgy including the process units of the present disclosure;

FIG. 6 shows a graph of the effect of temperature on the nickel leaching effect of an embodiment of the present disclosure;

FIG. 7 shows a graph of the effect of acid ore ratio on the nickel leaching effect of an embodiment of the present disclosure;

FIG. 8 shows a graph of the effect of liquid-solid ratio on the nickel leaching effect of an embodiment of the present disclosure;

FIG. 9 shows a graph of the effect of holding time on the nickel leaching effect of an embodiment of the present disclosure;

FIG. 10 shows a graph of the effect of ore particle size on the nickel leaching effect of an embodiment of the present disclosure;

FIG. 11 shows a schematic flow chart of a method for generating a process unit according to a further embodiment of the present disclosure;

FIG. 12 shows a structural block diagram of an apparatus for generating a process unit according to a further embodiment of the present disclosure;

FIG. 13 shows a schematic flow chart of a method for designing a complex system flow and modeling a digital model according to an embodiment of the present disclosure;

FIG. 14 shows a schematic structural diagram of an apparatus for designing a complex system flow and modeling a digital model according to an embodiment of the present disclosure;

FIG. 15 shows a system process flow chart of low-grade lateritic nickel ore hydrometallurgy according to an embodiment of the present disclosure;

FIG. 16 shows a schematic structural diagram of a three-stage preheating process unit of low-grade laterite nickel ore hydrometallurgy according to an embodiment of the present disclosure;

FIG. 17 shows a schematic structural diagram of a link unit of low-grade lateritic nickel ore hydrometallurgy according to an embodiment of the present disclosure;

FIG. 18 shows a schematic structural diagram of connection manner between a link unit and process units according to an embodiment of the present disclosure;

FIG. 19 shows a partially structure schematic diagram of a digital model architecture of low-grade lateritic nickel ore hydrometallurgy according to an embodiment of the present disclosure;

FIG. 20 shows a partially structure schematic diagram of a digital model of low-grade laterite nickel ore hydrometallurgy according to an embodiment of the present disclosure.

### DETAILED DESCRIPTION OF THE EMBODIMENTS

Hereinafter, the technical solutions in the present disclosure are described clearly and completely in conjunction with the embodiments and the accompanying drawings in the embodiments to make the objectives, technical solutions and advantages of the present disclosure clear. It is apparent that the described embodiments are only a few rather than all of the embodiments according to the present disclosure. Any other embodiments acquired by those skilled in the art based on the embodiments in the present disclosure without any creative efforts fall within the protection scope of the present disclosure.

The technical solutions according to the embodiments of the present disclosure are described in detail below with reference to the drawings.

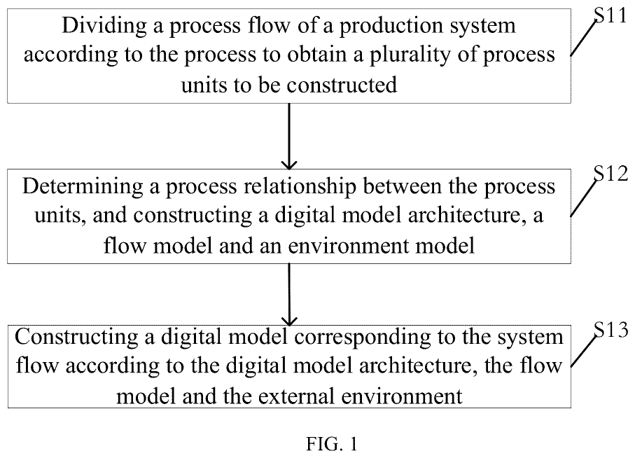

Reference is made to FIG. 1, which shows a flow chart of a method for modeling a digital model of a production system according to an embodiment of the present disclosure, including:
S11: dividing a process flow of a production system according to the process to obtain a plurality of process units to be constructed;
S12: determining a process relationship between the process units, and constructing a digital model architecture, a flow model and an environment model;
S13: constructing a digital model corresponding to the system flow according to the digital model architecture, the flow model and the external environment.

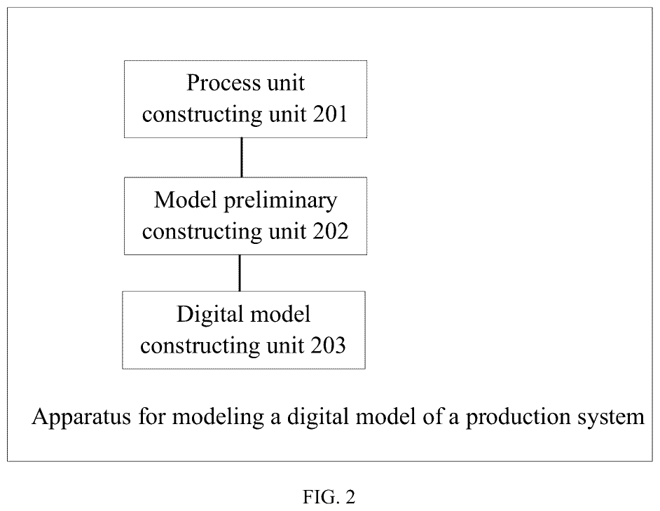

Reference is made to FIG. 2, which shows a structural block diagram of an apparatus for modeling a digital model of a production system according to an embodiment of the present disclosure, where the apparatus includes:
a process unit constructing unit 201, configured to divide a process flow of a production system according to the process to obtain a plurality of process units to be constructed;
a model preliminary constructing unit 202, configured to determine a process relationship between the process units, and constructing a digital model architecture, a flow model and an environment model;
a digital model constructing unit 203, configured to construct a digital model corresponding to the system flow according to the digital model architecture, the flow model and the external environment.

Wherein the process unit may in particular include a production device, has substantial production capacity, includes physical or chemical changes or both.

In the first implementation, the model preliminary constructing unit includes:
a device group model constructing module, configured to construct a device group model corresponding to each process unit respectively, where the device group model includes at least one agent, and the agents are connected in series or in parallel with each other;
a flow model constructing module, configured to construct a flow model corresponding to each process unit respectively, wherein the flow model configures obtained flow data for the process unit, and the flow data comprises inlet flow data and/or outlet flow data, and the data types in the flow data at least comprise one or more of substance flow data, energy flow data, value flow data and information flow data;
an environment model constructing module, configured to construct an environment model corresponding to each process unit respectively, wherein the environment model configures obtained environment data for the process unit, and the data types of the environment data comprise one or more of water supply data, heat supply data, electricity supply data, steam supply data, material data, energy data and kinetic energy supply data.

In the second implementation, the model preliminary constructing unit includes:
a system flow definition module, configured to define a system flow chart, wherein the system flow chart comprises function charts and a flow sequence between the function charts;
a process flow chart determining module, configured to analyze the system flow chart into a plurality of processes and form the plurality of processes into a system process flow chart;
a device configuration module, configured to configure a device for realizing process functions according to the process functions and the process capacities;
a process unit determining module, configured to construct the device as an agent, construct a process unit according to the agent and determine a process relationship of the process unit.

Further, the apparatus further includes:
a model optimization unit, configured to simulate, verify and reconstruct the system flow through the digital model so as to optimize the system flow.

Further, the process flow chart determining module is specifically configured to analyze each of the function charts into a plurality of processes and a process sequence between the processes; and form the plurality of the processes into a system process flow chart according to the flow sequence and the process sequence.

Further, the model preliminary constructing unit includes:
a link unit integration module, configured to structure the interaction and the cooperation relationship between the process units and integrally construct a link unit;
a model preliminary constructing module, configured to construct a digital model
architecture according to the system process flow chart by using the process unit and the link unit, and construct a flow model and an external environment, wherein the external environment comprises water, electricity, steam and materials;
a digital model constructing module, configured to construct a digital model corresponding to the system flow according to the digital model architecture, the flow model and the external environment.

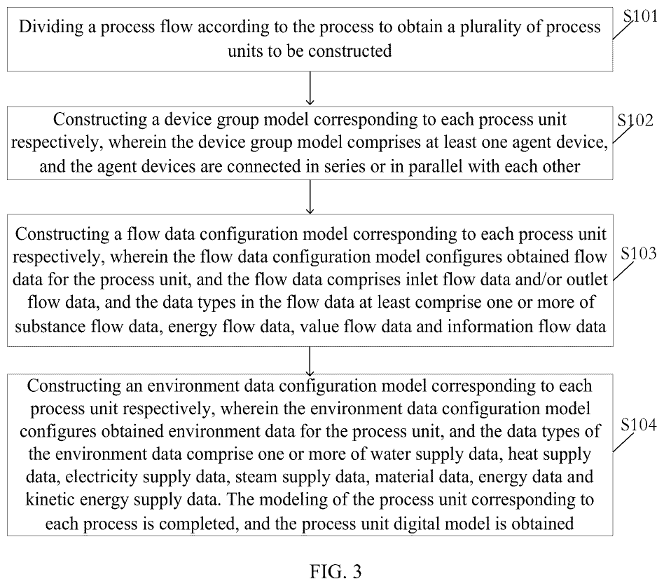

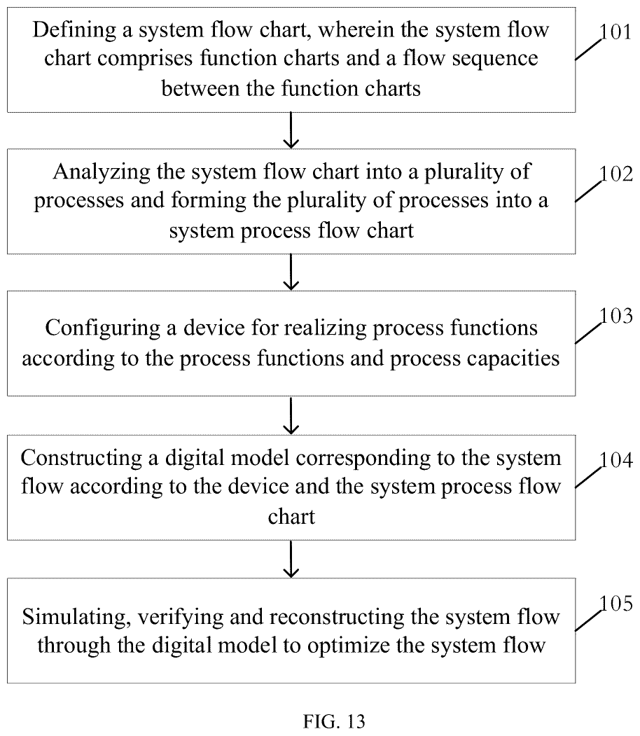

The embodiments of the present disclosure are described in detail below in terms of both a method for modeling and generating a process unit (referring to FIG. 3 to FIG. 12 and the description) and a method for designing a complex system flow and modeling a digital model (referring to FIG. 13 to FIG. 20 and the description).

An embodiment of the present disclosure provides a method for modeling a process unit, as shown in FIG. 3, including:

Step S101: dividing a process flow according to the process to obtain a plurality of process units to be constructed;
in the specific implementation of this step, in the non-ferrous metallurgy application, the function of each process unit, the production capacity parameter information and the like are determined based on the basic metallurgy at the microscopic level and the professional metallurgy technology at the mesoscopic level. The process unit is a process step, namely a process, in the non-ferrous metallurgy process. The function of the process unit refers to the specific function realized in the nonferrous metallurgy production process, such as: comparing the functions of leaching, washing, purifying, enriching, separating, oxidizing, reducing, refining, electrolyzing and the like of minerals or elements. Specifically, the metallurgical process is divided into process units according to the sequence of process steps according to the process flow, and each process unit corresponds to a process.

Step S102: constructing a device group model corresponding to each process unit respectively, wherein the device group model comprises at least one agent device, and the agent devices are connected in series or in parallel with each other;
in the specific implementation of this step, a functional device group model is constructed, the functional device group model is configured according to the function of a process unit to be constructed and the production capacity parameter information, wherein the device group model comprises at least one agent device, and the agent devices are connected in series or in parallel with each other; specifically, the type and number of agent devices corresponding to the target process unit are determined for the function and production capacity parameter information of the target process unit.

Step S103: constructing a flow data configuration model (also referred to as a “flow model” for short) corresponding to each process unit respectively, wherein the flow data configuration model configures obtained flow data for the process unit, and the flow data comprises inlet flow data and/or outlet flow data, and the data types in the flow data at least comprise one or more of substance flow data, energy flow data, value flow data and information flow data;
in the specific implementation of this step, the substance flow data comprises flow direction information of the material; the energy flow data includes energy information of electric energy, steam energy, reaction heat and the like; the value flow data includes information such as cost information and profit information for performing the process unit, the information flow data includes: information such as substance flow information, control operation information, and detection information.

Step S104: constructing an environment data configuration model (also referred to as an “environment model” for short) corresponding to each process unit respectively, wherein the environment data configuration model configures obtained environment data for the process unit, and the data types of the environment data comprise one or more of water supply data, heat supply data, electricity supply data, steam supply data, material data, energy data and kinetic energy supply data. The modeling of the process unit is completed, and the process unit digital model is obtained.

In the specific implementation of this step, the environmental data configuration model configures obtained environment data for the process unit, and the data types of the environment data comprise one or more of water supply data, heat supply data, electricity supply data, steam supply data, material data, energy data and kinetic energy supply data. For example, the environmental data configuration model may configure the water supply data; further may configure the heat supply data and the electricity supply data; and further may configure the water supply data, the heat supply data, the electricity supply data, the steam supply data and the material data.

The present disclosure completes the construction of the digital model of the process unit by constructing the device group model, by constructing the flow data configuration model, and by constructing the environment data configuration model. The modeling method in the present disclosure can model the process flow of a complex system, simplifying the construction process of the complex production system.

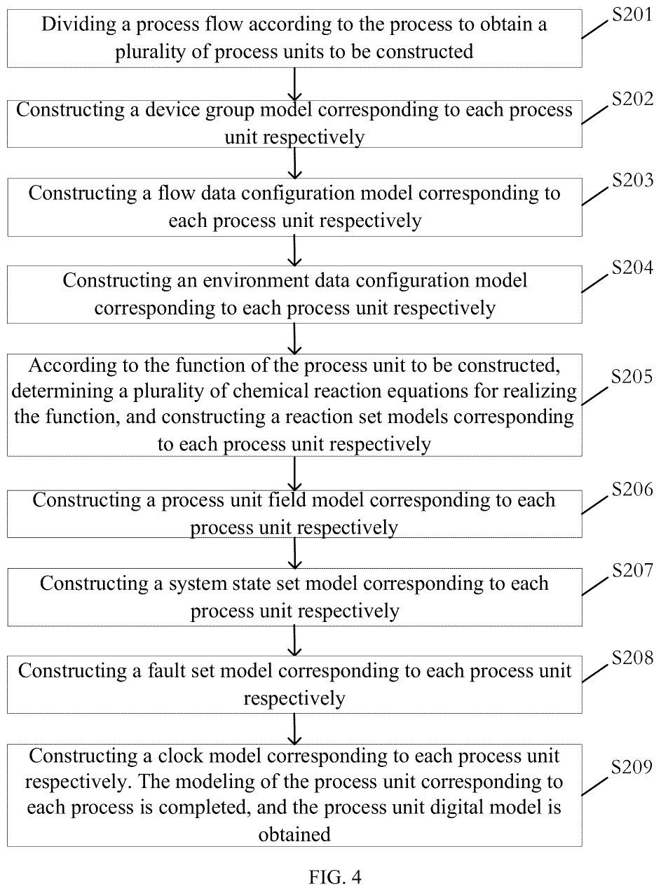

Another embodiment of the present disclosure provides another method for modeling a process unit, as shown in FIG. 4, including:

Step S201: dividing a process flow according to the process to obtain a plurality of process units to be constructed;
in the specific implementation of this step, in the non-ferrous metallurgy application, the function of each process unit, the production capacity parameter information and the like are determined based on the basic metallurgy at the microscopic level and the professional metallurgy technology at the mesoscopic level. The process unit is a process step, namely a process, in the non-ferrous metallurgy process. The function of the process unit refers to the specific function realized in the nonferrous metallurgy production process, such as: comparing the functions of leaching, washing, purifying, enriching, separating, oxidizing, reducing, refining, electrolyzing and the like of minerals or elements. Specifically, the metallurgical process is divided into process units according to the sequence of process steps according to the process flow, and each process unit corresponds to a process step, namely a process.

Step S202: constructing a device group model corresponding to each process unit respectively, wherein the device group model comprises at least one agent device, and the agent devices are connected in series or in parallel with each other;
in the specific implementation of this step, the type of the agent devices and the number of the agent devices corresponding to the process unit are determined according to the function of the process unit and the production capacity parameter information. For example, in the three-stage preheating process unit, for the three-stage preheating function, determining the type of the agent device corresponding to the three-stage preheating process unit as a preheater, where the three agent device preheaters form a device group, and the three preheaters are connected in series; and determining that the type of the agent device corresponding to the grinding process unit is grinding device such as a ball mill according to the function of the grinding process unit and the production capacity parameter information of the grinding process unit, wherein the number of the grinding devices is one, and the device group of the grinding process unit is a ball mill.

Step S203: constructing a flow data configuration model corresponding to each process unit respectively, wherein the flow data configuration model configures obtained flow data for the process unit, and the flow data comprises inlet flow data and/or outlet flow data, and the data types in the flow data at least comprise one or more of substance flow data, energy flow data, value flow data and information flow data;
in the specific implementation of this step, firstly, constructing a substance flow model; secondly, constructing an energy flow model and a value flow model according to the substance flow; and finally, constructing an information flow model according to the substance flow, the energy flow and the value flow. The substance flow data includes flow direction information of the material; the energy flow data includes energy information of electric energy, steam energy, reaction heat and the like; the value flow data includes information such as cost information and profit information for performing the process unit, the information flow data includes information such as substance flow information, control operation information, and detection information. The existing logistics simulation and system simulation software can perform flow simulation of substance flow and limited information flow and cannot meet the actual requirements for the simulation of information flow, energy flow and value flow. The modeling method in the present disclosure fully considers substance flow, energy flow, value flow and information flow, and may digitally display various flow data information.

Step S204: constructing an environment data configuration model corresponding to each process unit respectively, wherein the environment data configuration model configures obtained environment data for the process unit, and the data types of the environment data comprise one or more of water supply data, heat supply data, electricity supply data, steam supply data, material data, energy data and kinetic energy supply data;
in the specific implementation of this step, the environmental data configuration model configures obtained environment data for the process unit, and the data types of the environment data comprise one or more of: water supply data, heat supply data, electricity supply data, steam supply data, material data, energy data and kinetic energy supply data. For example, the environmental data configuration model may configure the water supply data; further may configure the heat supply data and the electricity supply data; and further may configure the water supply data, the heat supply data, the electricity supply data, the steam supply data and the material data.

Step S205: according to the function of the process unit to be constructed, determining a plurality of chemical reaction equations for realizing the function, and constructing a reaction set models corresponding to each process unit respectively;
in the specific implementation of this step, a plurality of chemical reaction equations for realizing each function are determined according to the function of each process unit, for example, the metallurgical chemical reaction equation of the high-pressure acid leaching process unit comprises:

$$NiO + {H}_{2} {SO}_{4} = {NiSO}_{4} + {H}_{2} O$$

$$CoO + {H}_{2} {SO}_{4} = {CoSO}_{4} + {H}_{2} O$$

$$MgO + {H}_{2} {SO}_{4} = {MgSO}_{4} + {H}_{2} O$$

$$MnO + {H}_{2} {SO}_{4} = {MnSO}_{4} + {H}_{2} O$$

$$2 {F}_{e} OOH = {Fe}_{2} {O}_{3} + {H}_{2} O$$

$$2 {Al ( OH )}_{3} + 3 {H}_{2} {SO}_{4} = {{Al}_{3} ( {SO}_{4} )}_{3} + 3 {H}_{2} O$$

A process unit reaction set model corresponding to the high-pressure acid leaching process unit is constructed according to each of the chemical reaction equations.

Step S206: constructing a process unit field model corresponding to each process unit respectively, wherein the process unit field model is reaction parameter information for realizing the chemical reaction equations in the reaction set, and the reaction parameter information includes: one or more of storage volume information, temperature information, pressure information, pH information, substance information, concentration information, viscosity information, flow field rate information and gradient information;
in the specific implementation of this step, the reaction parameter information includes storage volume information, temperature information, pressure information, pH information, substance information, concentration information, viscosity information, flow field rate information, gradient information and the like. According to different functions to be implemented, the reaction data set includes different reaction parameter information.

Step S207: constructing a system state set model corresponding to each process unit respectively;
in the specific implementation of this step, the constructing a system state set model includes the following steps:

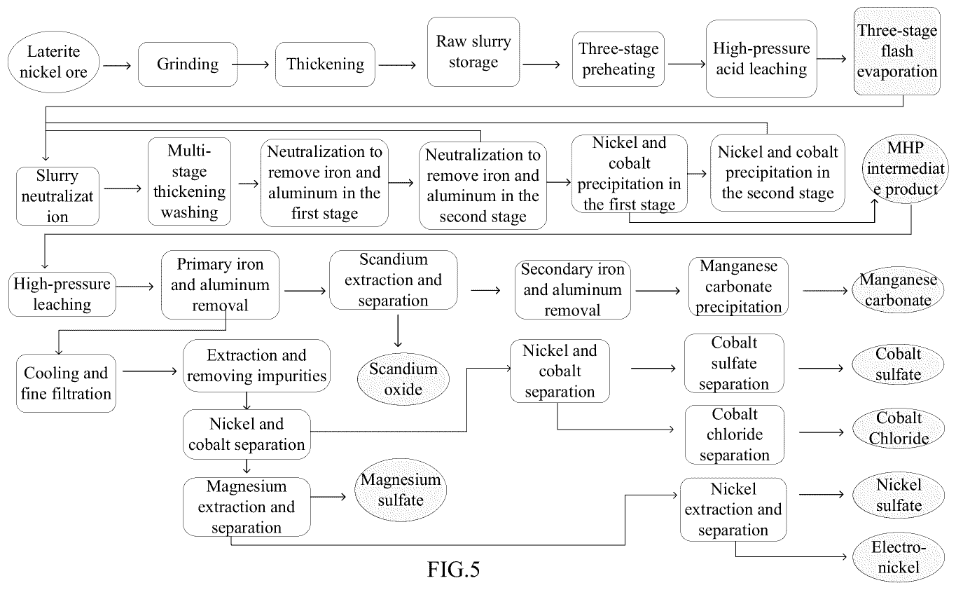

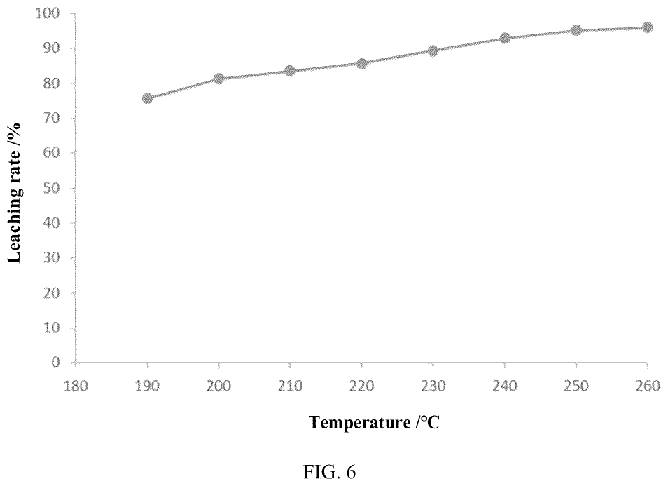

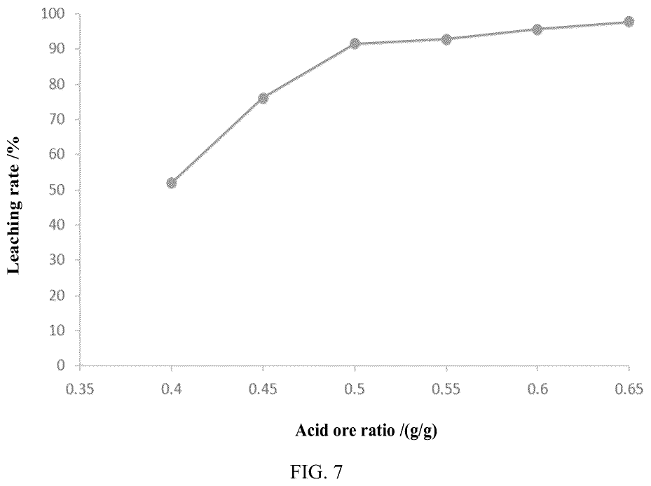

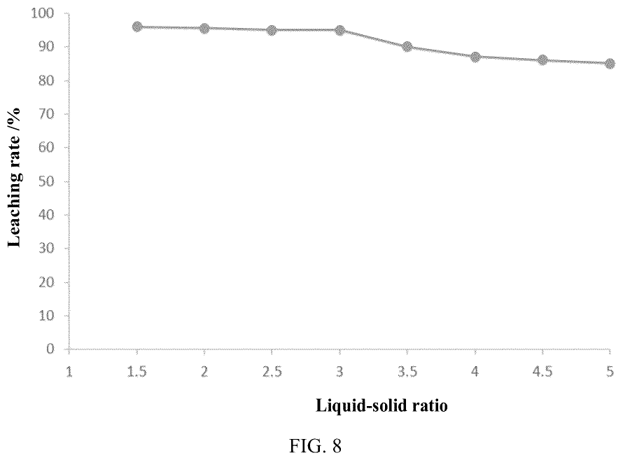

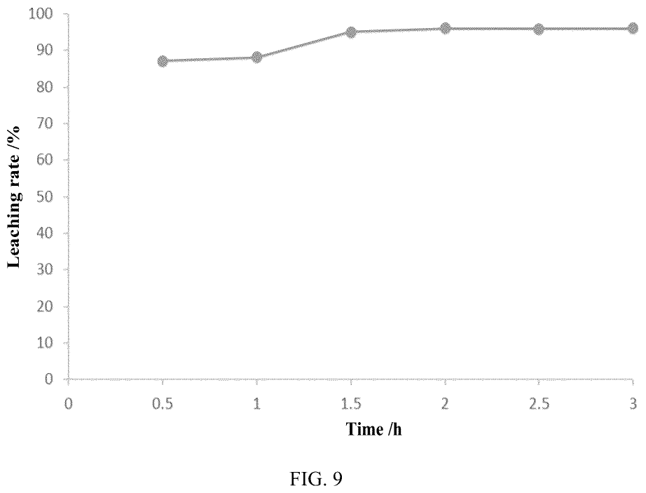

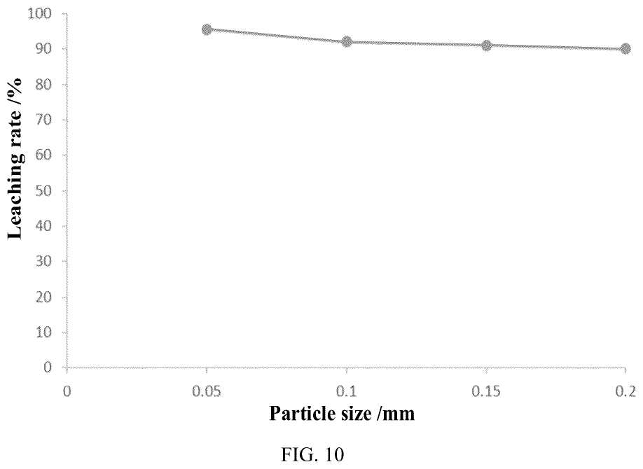

step A: analyzing each reaction parameter information by applying a preset factor analysis method, and determining target reaction parameter information and a value range corresponding to the target reaction parameter information;
in the specific implementation of this step, the preset factor analysis method may be a theoretical derivation method, a test method, a production measurement data method, a neural network and the like. Each target effect factor may be determined with the test method. For example, FIG. 5 shows a flow chart of the process of laterite nickel ore hydrometallurgy including the process units of the present disclosure. In the laterite nickel ore hydrometallurgy, the determination of the target effect factor of the process unit, namely the high-pressure acid leaching process by applying a single-factor test method specifically includes, firstly, the effect of temperature on leaching is determined by applying a single-factor analysis method. With the increase of temperature, the nickel leaching rate is significantly improved, which indicates that the increase of temperature facilities improving the nickel leaching rate, and when the leaching temperature is 260° C., the nickel leaching rate reaches 95.6%. Meanwhile, with the increase of temperature, the iron leaching rate is reduced, and after the leaching temperature reaches 230° C., the iron leaching rate is lower than 5%, and the concentration of iron in the solution is low. The increase of temperature facilities the selective and directional leaching of nickel laterite ore, that is, the nickel leaching rate may be increased, and the iron leaching rate may be inhibited. A graph of the effect of temperature on the nickel leaching effect is shown in FIG. 6. Then, the effect of acid ore ratio on leaching is determined by applying a single-factor analysis method, where the acid ore ratio is an important factor affecting the nickel leaching rate. The nickel leaching rate may be improved by increasing the acid ore ratio. When the acid ore ratio is increased from 0.4:1 to 0.5:1, the leaching rate is significantly increased. When the acid ore ratio is 0.65:1, the nickel leaching rate reaches the maximum value of 97.1%, and the iron leaching rate is also increased with the increase of acid ore ratio, but all at a lower level. The acid consumption in the pressurized leaching process mainly depends on the magnesium content in the ore, sufficient sulfuric acid is added for completely leaching nickel in the ore, but the high acid ore ratio may increase the cost, and the hydrolysis of Fe and the subsequent treatment of the leached solution are also not facilitated due to the high free acid of the leached solution. In the test, the nickel leaching rate reaches 95% when the acid ore ratio is 0.6:1, and the leaching rate is only increased from 95% to 97.1% when the acid ore ratio is increased from 0.6:1 to 0.5:1. The acid ore ratio of 0.6:1 is selected as the optimal acid ore ratio in consideration of cost and acidity of the leached solution. A graph of the effect of acid ore ratio on the nickel leaching effect is shown in FIG. 7. Further, the effect of liquid-solid ratio on leaching is determined by applying a single-factor analysis method. The nickel leaching rate decreases with the increase of liquid-solid ratio, this is because the increase of liquid-solid ratio decreases the free acid in solution, which is not conducive to the leaching of nickel. The iron leaching rate also decreases with the increase of liquid-solid ratio, this is because, on one hand, decreasing acidity is not conducive to leaching iron due to the increasing liquid-solid ratio, and on the other hand, low acidity is beneficial to the hydrolysis of iron, resulting in decreasing the total iron leaching rate. A graph of the effect of liquid-solid ratio on the nickel leaching effect is shown in FIG. 8. Further, the effect of time on leaching is determined by applying a single-factor analysis method. With the increase of time, the leaching rates of nickel and iron do not change much, which indicates that the leaching reaction is performed quickly under the conditions of high temperature and high pressure, and just make sure there is enough reaction time. A graph of the effect of holding time on the nickel leaching effect is shown in FIG. 9. Further, the effect of ore particle size on the leaching is determined by applying a single-factor analysis method. The leaching rate is hardly affected by the ore particle size, and the leaching rate in each range of the particle size can substantially reach 90%. As long as the particle size is within a certain range, it will not affect the nickel leaching rate. A graph of the effect of ore particle size on the nickel leaching effect is shown in FIG. 10. As known from single-factor test, main factors that affect the high-pressure leaching process are 3 in total, namely temperature, acid ore ratio and liquid-solid ratio. It is sufficient to satisfy a certain range of time and ore particle size, where time >1 h and ore particle size −0.075 mm. According to the test conclusion and the process requirements, temperature, acid ore ratio, liquid-solid ratio, pressure, autoclave volume and stirring speed are determined as the intermediate effect factors. Wherein the value range of the intermediate effect factors are as follows: temperature T=250-270° C., acid ore ratio K=200-230 Kg/t of the ore, liquid-solid ratio F=1.5:1-3:1, pressure P=4-5 MPa, autoclave volume V=800m3, diameter 5.6 m, length 42 m, stirring speed n=80-120 rpm, time T>1 h, ore particle size: −0.075 mm. Each of the intermediate effect factors is filtered to obtain a plurality of target effect factors for determining the state simulation parameters of the target system. Specifically, after filtering each of the intermediate effect factors determined by the single-factor analysis method, the main factors that affect the nickel leaching rate are obtained: temperature, acid ore ratio and liquid-solid ratio, to obtain the target effect factors.

Step B: constructing a system state function corresponding to the current process unit by taking the target reaction parameter information as a system state variable;
in the specific implementation of this step, the system state function may be represented by the following equation 1:

$${η}_{Ni} = f ( S ) \qquad ( 1 )$$

Wherein S is system state representing nickel leaching rate, which system state may be represented by the following equation 2:

$$S = \{ T , K , F \} \qquad ( 2 )$$

Wherein, T represents temperature, K represents acid ore ratio, F represents liquid-solid ratio, and T, K and F are target effect factors. The type and quantity of the target effect factors are different for the non-ferrous metallurgy process of different ores in practical application, and the system state variable and quantity need to be adjusted according to the practical metallurgical process.

Step C: determining a plurality of parameter values corresponding to each of the system state variables respectively in each value range;
in the specific implementation of this step, comprehensive tests are carried out according to the target effect factors selected in the single-factor test: temperature, acid ore ratio and liquid-solid ratio. The test data are shown in Table 1:

TABLE 1

| Temperature | Acid ore ratio | Liquid-solid ratio |
|---|---|---|
| 220 | 0.4 | 2:1 |
| 240 | 0.5 | 3:1 |
| 260 | 0.6 | 4:1 |

27 test groups are required. The result of each test group corresponds to a system state, for a total of 27 system states, and the specific function value in each system state is calculated by applying an interpolation method according to actual variable values such as temperature, acid ore ratio, liquid-solid ratio. The 27 groups of test data are shown in Table 2:

TABLE 2

| Test | System | | Acid ore | Liquid-solid | Nickel |
|---|---|---|---|---|---|
| No. | state No. | Temperature | ratio | ratio | leaching rate |
| 1 | state 1 | 220 | 0.4 | 2:1 | 68.44 |
| 2 | state 2 | 220 | 0.5 | 3:1 | 81.1 |
| 3 | state 3 | 220 | 0.6 | 4:1 | 86.5 |
| 4 | state 4 | 240 | 0.4 | 2:1 | 66.01 |
| 5 | state 5 | 240 | 0.5 | 3:1 | 85.33 |
| 6 | state 6 | 240 | 0.6 | 4:1 | 95.21 |
| . . . | . . . | . . . | . . . | . . . | . . . |
| 27 | state 27 | 260 | 0.6 | 4:1 | 96.6 |

Step D: matching the parameter values to construct a system state set model meeting the preset design requirement.

Specifically, a target system state model that satisfies the predetermined design requirements is determined from the system state information based on each leaching rate result.

Step S208: constructing a fault set model corresponding to each process unit respectively, wherein the fault set model of the process unit configures fault information of each functional device and each pipeline for the process unit, wherein the fault information comprises the fault type and maintenance information corresponding to the fault type;
in the specific implementation of this step, the fault set is a set of various possible faults and corresponding parameter information such as frequency, distribution pattern, maintenance time. For example, in the high-pressure acid leaching process unit, the failures of the autoclave are shown in Table 3 below:

TABLE 3

| | Number of | | |
|---|---|---|---|
| | shutdowns | Distribution | Maintenance |
| Main factor | per year | pattern | time (h) |
| autoclave discharge | 2 | normal distribution | 48 |
| pipeline cleaning | | | |
| autoclave AC stirrer | 2 | normal distribution | 30 |
| shutdown | | | |
| troubleshooting and | 4 | normal distribution | 6 |
| replacement of key | | | |
| instruments | | | |
| autoclave feed pump | 4 | normal distribution | 4 |
| failure shutdown | | | |
| feeding pump | 4 | normal distribution | 8 |
| failure shutdown | | | |
| DCS failure | 2 | normal distribution | 8 |

Step S209: constructing a clock model corresponding to each process unit respectively, wherein the clock model of the process unit configures time domain information and tempo time information for the process unit. The modeling of the process unit corresponding to each process is completed, and the process unit digital model is obtained.

In the specific implementation of this step, the time domain information is the time point when the unit substance flow leaves the current process unit minus the time point when the unit substance flow enters the current sub-process unit. The time domain information of the process unit comprises a plurality of tempo times. The tempo time is the time required for the process unit to complete a basic action of the nonferrous metallurgy, wherein a basic action may be a certain amount of chemical reaction, a basic action may be a certain amount of separation of the substance flow, a basic action may be a certain amount of leaching of the substance flow, etc. A time sequence is established by taking the tempo time as basic unit time, that is, each tempo time triggers an action of the nonferrous metallurgy to advance the non-ferrous metallurgical process. So as to complete the modeling of the process unit corresponding to each process and obtain a process unit digital model.

The present disclosure completes the modeling of the process unit by constructing the device group model, by constructing the flow data configuration model, by constructing the environment data configuration model, by constructing the reaction set model, by constructing the process unit field model, by constructing the system state set model, by constructing the process unit fault set model and by constructing the process unit clock model to obtain a process unit digital model. The present disclosure can model the process flow of a complex system, simplifying the construction process of the complex production system, and the present disclosure comprehensively considers a plurality of factors to model the process unit, so that the constructed model is more accurate.

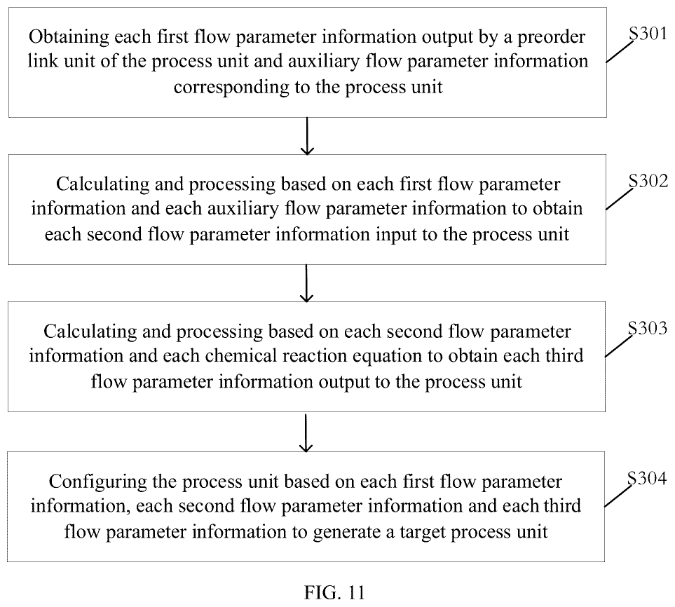

In another embodiment of the present disclosure, a method for generating a process unit is provided by using the process unit digital model constructed according to the above method for modeling a process unit. As shown in FIG. 11, the method includes:

step S301: obtaining each first flow parameter information output by a preorder link unit of the process unit and auxiliary flow parameter information corresponding to the process unit;
in the specific implementation of this step, each first flow parameter information is substance flow data, energy flow data, information flow data and value flow data which are output to the process unit after being processed by the preorder link unit; the auxiliary flow parameter information is auxiliary substance flow data added for realizing the function of the process unit, and the auxiliary substance flow data comprises substance flow data of water, catalyst, oxidant and the like. Wherein the link unit comprises an auxiliary device, does not have substantial production capacity and mainly comprises physical changes.

Step S302: calculating and processing based on each first flow parameter information and each auxiliary flow parameter information to obtain each second flow parameter information input to the process unit;
in the specific implementation of this step, an auxiliary substance flow is added into the process unit, and the auxiliary substance flow is combined with the substance flow output by the preorder link unit of the process unit to obtain each second flow parameter information input into the process unit.

Step S303: calculating and processing based on each second flow parameter information and each chemical reaction equation to obtain each third flow parameter information output to the process unit;
in the specific implementation of this step, the substance flow information produced when each chemical reaction equation reaches an equilibrium state is determined based on the second flow parameter information and each chemical reaction equation, and the substance flow information in the third flow parameter information is obtained. The produced substance flow information is processed to obtain value flow data in the third flow parameter information. And finally, the information flow data in the third flow parameter information is obtained according to the substance flow information, the energy flow information, and the value flow information.

Step S304: configuring the process unit based on each first flow parameter information, each second flow parameter information and each third flow parameter information to generate a target process unit.

In a specific implementation of this step, the first flow parameter information, the second flow parameter information, and the third flow parameter information include substance flow data, energy flow data, value flow data, and information flow data; wherein the substance flow data includes flow direction information of the material; the energy flow data includes energy information of electric energy, steam energy, reaction heat and the like; the value flow data includes information such as cost information and profit information for performing the process unit, the information flow data includes information such as substance flow information, control operation information, and detection information.

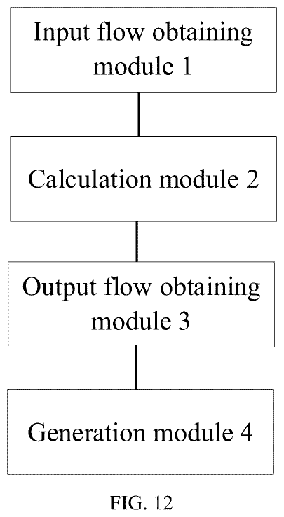

Another embodiment of the present disclosure provides an apparatus for generating a process unit, as shown in FIG. 12, including:
an input flow obtaining module 1, configured to obtain each first flow parameter information output by the preorder link unit of the process unit and auxiliary flow parameter information corresponding to the process unit;
a calculation module 2, configured to calculate and process based on each first flow parameter information and each auxiliary flow parameter information to obtain each second flow parameter information input to the process unit;
an output flow obtaining module 3, configured to calculate and process based on each second flow parameter information and each chemical reaction equation to obtain each third flow parameter information output to the process unit;
a generation module 4, configured to configure the process unit based on each first flow parameter information, each second flow parameter information and each third flow parameter information to generate a target process unit.

In a specific implementation, the first flow parameter information, the second flow parameter information, and the third flow parameter information include substance flow data, energy flow data, value flow data, and information flow data. Wherein the substance flow data includes flow direction information of the material. The energy flow data includes at least one energy information of electric energy, steam energy and reaction heat. The value flow data includes one or more of cost information and profit information for performing the process unit, the information flow data includes one or more of substance flow information, control operation information and detection information.

Another embodiment of the present disclosure provides a storage medium. The storage medium stores a computer program. The computer program, when executed by a processor, is configured to implement the following method steps:
step 1: dividing a process flow according to the process to obtain a plurality of process units to be constructed;
step 2: constructing a device group model corresponding to each process unit respectively, wherein the device group model comprises at least one agent device, and the agent devices are connected in series or in parallel with each other;
step 3: constructing a flow data configuration model corresponding to each process unit respectively, wherein the flow data configuration model configures obtained flow data for the process unit, and the flow data comprises inlet flow data and/or outlet flow data, and the data types in the flow data at least comprise one or more of substance flow data, energy flow data, value flow data and information flow data;
step 4: constructing an environment data configuration model corresponding to each process unit respectively, wherein the environment data configuration model configures obtained environment data for the process unit, and the data types of the environment data comprise one or more of water supply data, heat supply data, electricity supply data, steam supply data, material data, energy data and kinetic energy supply data. The modeling of the process unit corresponding to each process is completed, and the process unit digital model is obtained.

Those skilled in the art should understand that all or some of procedures of the method in the foregoing embodiments may be implemented by a computer program instructing relevant hardware. The computer program may be stored in a non-volatile computer-readable storage medium. The procedures of the foregoing method embodiments may be implemented when the program is executed. Any reference to a memory, a storage, a database, or another medium used in the embodiments provided in this disclosure may include a non-volatile and/or volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache. As an illustration instead of a limitation, the RAM is available in multiple forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a Rambus direct RAM (RDRAM), a direct Rambus dynamic RAM (DRDRAM), and a Rambus dynamic RAM (RDRAM).

Those skilled in the art can clearly understand that, for convenience and conciseness of description, the above example of division of functional units and modules is described. In actual applications, the functions may be allocated to different functional units and modules as required. That is, the internal structure of the apparatus is divided into different functional units or modules, to perform all or part of the functions described above.

The specific implementation of the above method steps may refer to the embodiment of the method for modeling any process unit, and details are not described herein again in this embodiment.

The present disclosure completes the modeling of the process unit by constructing the functional device group model, by constructing the flow data configuration model, by constructing the environment data configuration model, by constructing the reaction set model, by constructing the process unit field model, by constructing the system state set model, by constructing the process unit fault set model and by constructing the process unit clock model to obtain a process unit digital model. The present disclosure can model the process flow of a complex system, simplifying the construction process of the complex production system, and the present disclosure comprehensively considers a plurality of factors to model the process unit, so that the constructed model is more accurate.

Another embodiment of the present disclosure provides an electronic device. The electronic device may be a server, including a processor, a memory, a network interface, and a database connected by a system bus. Wherein the processor of the electronic device is configured to provide computing and control capabilities. The memory of the electronic device includes non-volatile and/or volatile storage media, and internal memory. The non-volatile storage medium stores an operating system, a computer program, and a database. The internal memory provides an environment for running the operating system and the computer program stored in the non-volatile storage medium. The network interface of the electronic device is configured to communicate with an external client through a network connection. The electronic device program is executed by a processor to implement functions or steps at a service side of a method for modeling a process unit.

In an embodiment, an electronic device is provided, which may be a client. The electronic device includes a processor, a memory, a network interface, a display and an input apparatus connected by a system bus. Wherein the processor of the electronic device is configured to provide computing and control capabilities. The memory of the electronic device includes non-volatile storage media and internal memory. The non-volatile storage medium stores an operating system and a computer program. The internal memory provides an environment for running the operating system and the computer program stored in the non-volatile storage medium. The network interface of the electronic device is configured to communicate with an external server through a network connection. The electronic device program is executed by a processor to implement functions or steps at a client side of a method for modeling a process unit.

Another embodiment of the present disclosure provides an electronic device, which at least includes a memory and a processor, where the memory stores a computer program. The processor executes the computer program on the memory to perform following method steps:
step 1: dividing a process flow according to the process to obtain a plurality of process units to be constructed;
step 2: constructing a device group model corresponding to each process unit respectively, wherein the device group model comprises at least one agent device, and the agent devices are connected in series or in parallel with each other;
step 3: constructing a flow data configuration model corresponding to each process unit respectively, wherein the flow data configuration model configures obtained flow data for the process unit, and the flow data comprises inlet flow data and/or outlet flow data, and the data types in the flow data at least comprise one or more of substance flow data, energy flow data, value flow data and information flow data;
step 4: constructing an environment data configuration model corresponding to each process unit respectively, wherein the environment data configuration model configures obtained environment data for the process unit, and the data types of the environment data comprise one or more of water supply data, heat supply data, electricity supply data, steam supply data, material data, energy data and kinetic energy supply data. The modeling of the process unit corresponding to each process is completed, and the process unit digital model is obtained.

The embodiment provides a method for designing a complex system flow and modeling a digital model, as shown in FIG. 13, the method includes:

101: defining a system flow chart, wherein the system flow chart comprises function charts and a flow sequence between the function charts.

102: analyzing the system flow chart into a plurality of processes and forming the plurality of processes into a system process flow chart.

For the steps 101 and 102 of the embodiment, in a specific present disclosure scenario, the non-ferrous metallurgy has complex mineral components. Many accompanying valuable metal elements and large grade fluctuation result in long process flow, many branches and numerous and complicated circuits of the nonferrous metallurgy process, so that the nonferrous metallurgy production system is a complex system.

For the step 101 in the embodiment, specifically, taking the low-grade laterite nickel ore hydrometallurgy in non-ferrous metallurgy production as an example (wherein the components and occurrence of the laterite nickel ore are complex, the grade of main metal nickel is very low, the grade is 0.8-1.2%, and metal elements such as cobalt and scandium are accompanied, and the grade fluctuation is large. The low-grade laterite nickel ore is difficult to smelt by fire smelting, the hydrometallurgy is usually applied. The nonlinear unstable hydrometallurgical process flow of the laterite nickel ore is very complex. The problem that the design method of the complex system flow is lost or unreasonable in the past project results in low valuable metal extraction efficiency and incapability of production). A system flow chart of the low-grade laterite nickel ore hydrometallurgy is defined according to the microscopic metallurgical raw quantity at the molecular level and the professional process science at the mesoscopic level. And specifically, function charts and a flow sequence between the function charts are determined. For example, the function charts are the low-grade laterite nickel ore, high-pressure leaching, . . . , and the flow sequence between the functional charts is from the laterite nickel ore to high-pressure leaching, . . . , so as to obtain a system flow chart of the low-grade laterite nickel ore hydrometallurgy: laterite nickel ore—high-pressure leaching—washing—removing iron and aluminum—depositing nickel and cobalt—intermediate product—normal-pressure leaching—removing iron and aluminum—extracting and separation—product.

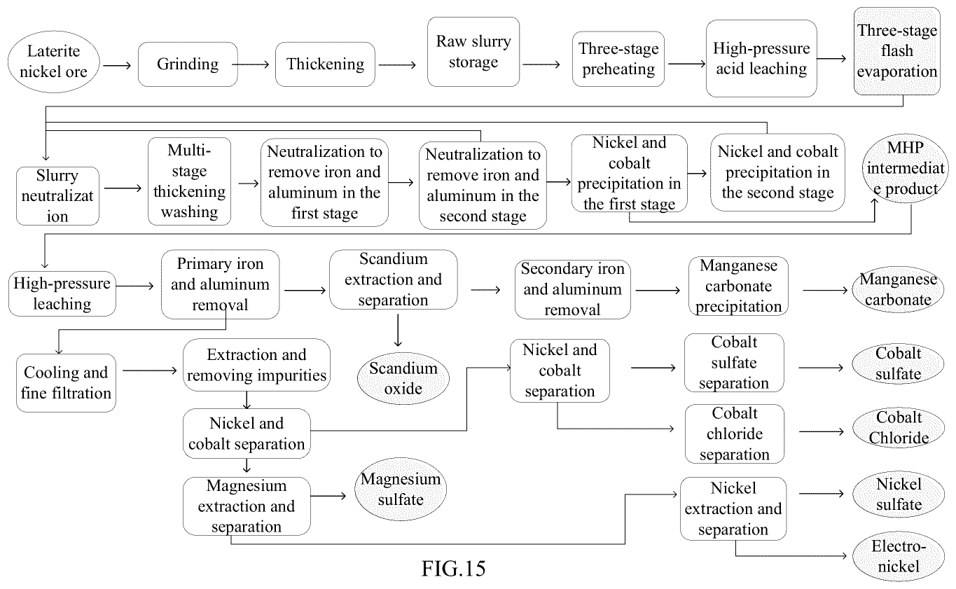

For step 102 of the embodiment, as an implementation, the analyzing a system flow chart into a plurality of processes and forming the processes into a system process flow chart includes: analyzing each functional chart into a plurality of processes and a process sequence between the processes; and forming the plurality of processes into a system process flow chart according to the flow sequence and the process sequence. Specifically, the functional chart of the laterite nickel ore is analyzed into three processes of grinding, thickening and raw slurry storage, and the process sequence between the three processes is from grinding to thickening to raw slurry storage. The functional chart of high-pressure leaching is analyzed into three processes of three-stage preheating, high-pressure acid leaching and three-stage flash evaporation, and the process sequence between the three processes is from three-stage preheating to high-pressure acid leaching to three-stage flash evaporation, . . . The processes under each functional chart are connected according to the process sequence, and all the functional charts are connected according to the process sequence, so that the system process flow chart of the low-grade lateritic nickel ore hydrometallurgy shown in FIG. 15 is obtained.

103: configuring a device for realizing process functions according to the process functions and process capacities.

For the embodiment, the configuring a device for realizing process functions according to the process functions and process capacities comprises: determining the type of the device according to the process function, and determining the number of the devices and the connection manner of the device according to the process capacities, wherein the process capacity refers to the substance flow processing capacity that a process can provide per unit of time in order to realize the function of the process. The connection manner of the device comprises serial connection between the devices, parallel connection between the devices, serial and parallel connection between the devices.

For example, the device for realizing the process function of grinding may be a ball mill, and one ball mill may realize the process function of grinding. And for example, the device for realizing the process function of three-stage preheating may be a preheater, and three preheaters in series are required to realize the process function of three-stage preheating.

104: constructing a digital model corresponding to the system flow according to the device and the system process flow chart.

For this embodiment, as an implementation, first, a device is constructed as an agent, and a process unit is constructed according to the agent; secondly, the interaction and the cooperation relationship between the process units are structured and the link unit is integrally constructed; thirdly, a digital model architecture is constructed according to the system process flow chart by using the process unit and the link unit; fourthly, a flow model and an external environment are constructed, wherein the external environment comprises water, electricity, steam and materials; and fifthly, a digital model corresponding to the system flow is constructed according to the digital model architecture, the flow model and the external environment.

For the first, where an agent is a virtual entity with independent attributes and autonomous behavioral capabilities and is able to interact with the environment. Therefore, constructing the device as an agent allows the device functions to be realized in a virtual environment. In step 102 of the embodiment, the number of the devices and the connection manner of the devices are configured, where the number of devices is the number of agents, and the connection manner of the devices is the connection manner of the agents. Specifically, a process unit is constructed according to the agents, that is, all the agents are connected according to the connection manner of the agents, so that the structure of the process unit is constructed, and then, on this basis, parameters affecting the realization of the process function are constructed, wherein the parameters comprise field factor, system state, fault set, time domain, clock and the like.

Wherein, the field factor is the main effect factor and insurance condition for realizing process functions. For example, for the process of high-pressure acid leaching, firstly, the leaching rates of nickel and cobalt are used as reference factors for measuring the realization degree of the process function, and then, the leaching rates of nickel and cobalt are determined to be affected by temperature, acid ore ratio, liquid-solid ratio, pressure, autoclave volume and stirring speed. That is, these are the field factors of the high-pressure acid leaching.

Wherein, the effect degrees of all field factors on the process function realization are different, a plurality with the largest effect degree is selected as system state variables (for example, the system state variables are temperature, acid ore ratio and liquid-solid ratio). Different system states may be provided due to different values of the system state variables, and different system states are the final overall process function realization degrees. Specifically, the graph of the effect of temperature, acid ore ratio and liquid-solid ratio on the leaching rate may be determined by means of a single-factor test, so that the values of temperature, acid ore ratio and liquid-solid ratio may be taken respectively. Then the leaching rate corresponding to each group of values is calculated (the functional relation of the leaching rate with the temperature, the acid ore ratio and the liquid-solid ratio may be determined by a test value, a production measured value and the like). Each group of leaching rates is corresponding to a system state, so as to carry out the state selection according to the requirements of different leaching rates. For example, the leaching rate in state 1 is 0.6844, the leaching rate in state 2 is 0.81, . . . , and the leaching rate in state 27 is 0.966. If the required leaching rate is greater than 0.95, the staff may configure state 27, that is, may directly set the degree of realization of the “high-pressure acid leaching” process function.

Wherein the fault set comprises various sets of possible faults, corresponding frequency, distribution pattern, maintenance time and the like.

Wherein the time domain is the time point when the unit substance flow leaves the current process unit minus the time point when the unit substance flow enters the process unit. The time domain includes a plurality of tempo times. The tempo time is the time required for the process unit to complete a basic action of the nonferrous metallurgy, wherein a basic action may be a certain amount of chemical reaction, a basic action may be a certain amount of separation of the substance flow, a basic action may be a certain amount of leaching of the substance flow, etc. The clock establishes a time sequence by taking the tempo time as basic unit time, that is, each tempo time triggers an action of the nonferrous metallurgy. The clock is a propeller for nonferrous metallurgy process.

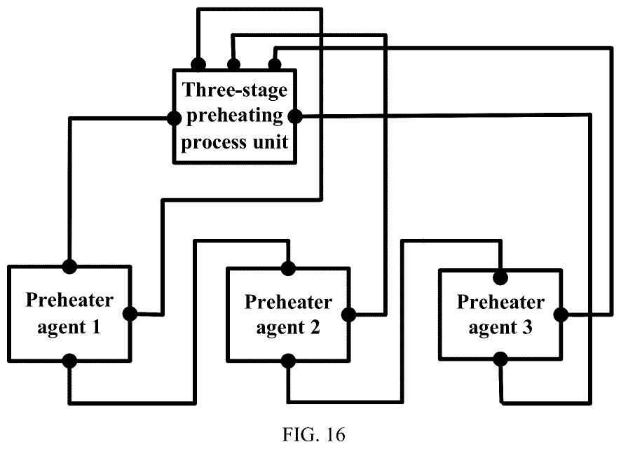

As shown in FIG. 16, taking the process of three-stage preheating of low-grade laterite nickel ore hydrometallurgy as an example, three preheaters are constructed as three preheater agents (preheater agent 1, preheater agent 2 and preheater agent 3). And the three preheater agents are connected in series with each other, connecting these three preheater agents in series to obtain the structural schematic diagram of the three-stage preheating process unit of low-grade laterite nickel ore hydrometallurgy.

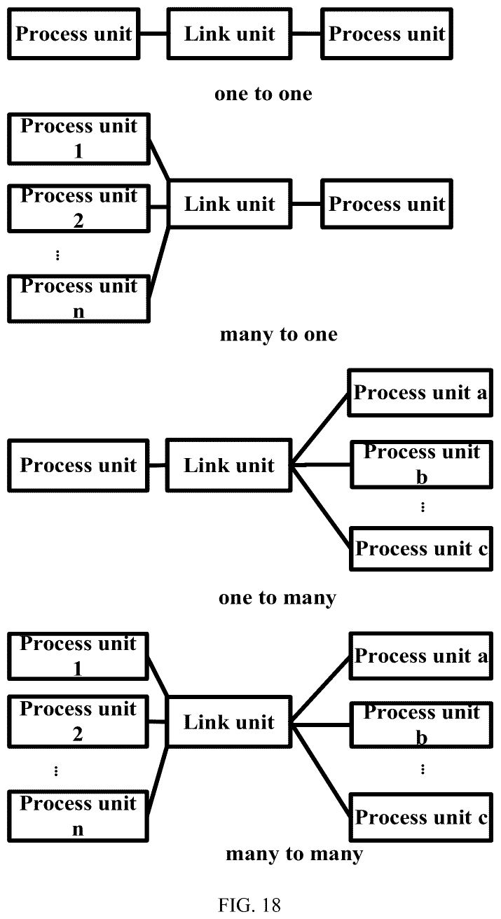

For the second, the interaction and the cooperation relationship between the process units are structured and the link unit is integrally constructed. Specifically, the preorder process unit to which the link unit is connected, the number of the preorder process units and the connection manner with the preorder process units are determined. And the subsequent process units to which the link unit is connected, the number of the subsequent process units and the connection manner with the subsequent process units are determined. as shown in FIG. 18, the connection manners of the process units and the link units include one-to-one, one-to-many, many-to-one, and many-to-many.

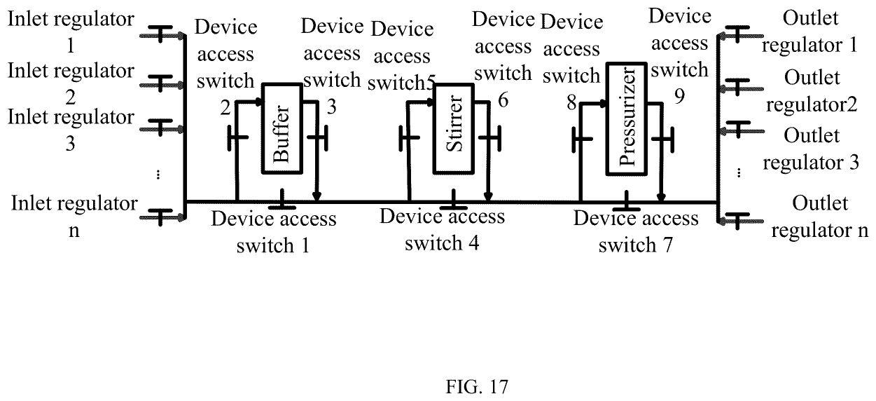

As shown in FIG. 17, provides a schematic structural diagram of a link unit of low-grade lateritic nickel ore hydrometallurgy, comprising: inlet regulators (inlet regulator 1, inlet regulator 2, inlet regulator 3, . . . , inlet regulator n numbered in FIG. 17, and all indicated closed in FIG. 17), inlet pipelines (not numbered in FIG. 17, wherein the pipeline is an apparatus to realize the communication of the link unit with the process unit), outlet regulators (outlet regulator 1, outlet regulator 2, outlet regulator 3, . . . , outlet regulator n numbered in FIG. 17, all indicated closed in FIG. 17), and outlet pipelines (not numbered in FIG. 17, wherein the pipeline is an apparatus to realize the communication of the link unit with the process unit); controlling the number of connected inlet pipelines by using an inlet regulator (an inlet pipeline corresponds to an inlet regulator, and the inlet regulator is opened, so that the corresponding inlet pipeline is connected, thereby controlling the number of connected inlet pipelines), and controlling the number of connected outlet pipelines by using an outlet regulator (similar to the inlet pipeline); constructing an apparatus access switch and a functional apparatus (each functional apparatus corresponds to a group of apparatus access switches, and in FIG. 17, a group corresponding to a buffer is numbered as a group of apparatus access switch 1, an apparatus access switch 2 and an apparatus access switch 3, a group corresponding to a stirrer is numbered as a group of apparatus access switch 4, an apparatus access switch 5 and an apparatus access switch 6, and a group corresponding to a pressurizer is numbered as an apparatus access switch 7, an apparatus access switch 8, and an apparatus access switch 9). As shown in FIG. 17, taking an example where the functional apparatus includes a buffer, a pressurizer, and a stirrer, the functional apparatus controlled to be accessed by the apparatus access switch obtains a link unit (for example, the apparatus access switch 1, the apparatus access switch 4, the apparatus access switch 8, and the apparatus access switch 9 are opened, namely connected, the apparatus access switch 2, the apparatus access switch 3, the apparatus access switch 5, the apparatus access switch 6, and the apparatus access switch 7 are off, namely not connected).

Specifically, if the process unit and the link unit are connected in a one-to-one manner, the number of inlet pipelines connected is controlled to be 1 by using the inlet regulator, and the number of outlet pipelines connected is controlled to be 1 by using the outlet regulator. If the process unit and the link unit are connected in a one-to-many (for example, one-to-three) manner, the number of inlet pipelines connected is controlled to be 1 by using the inlet regulator, and the number of outlet pipelines connected is controlled to be 3 by using the outlet regulator. Specifically, the inlet regulator 1 may be opened so that the inlet regulator 1 controls the inlet pipeline 1 to be opened, and other inlet pipelines are closed. The outlet regulator 1, the outlet regulator 2 and the outlet regulator 3 may be opened so that the outlet regulator 1 controls the outlet pipeline 1 to be opened, the outlet regulator 2 controls the outlet pipeline 2 to be opened, the outlet regulator 3 controls the outlet pipeline 3 to be opened, and other outlet pipelines are closed, which is not repeated herein.

A function of the required link unit is determined according to the function of the preorder process unit and the function of the subsequent process unit, thus the functional apparatus to which the link unit is connected is determined. (For example, it is determined whether to provide a stirrer according to the requirements of the preorder process unit and the subsequent process unit on stirring capacity). The number of the functional apparatuses and the connection manner between the functional apparatuses are determined according to the capacity information of the link unit (the capacity information of the link unit refers to the processing capacity of the link unit on substance flow in unit time. If only a stirrer is provided, the stirring capacity information of the stirrer (the information of volume, stirring speed, electricity and the like may be configured for the stirrer) is the capacity information of the link unit, and the amount of stirring capacity needed, the corresponding number of stirrers may be configured). Wherein the connection manner between the functional apparatuses comprises series connection, parallel connection, and series and parallel connection (for example, the functional apparatus comprises two buffers and a stirrer, wherein the two buffers both perform a buffering task and connect in parallel with each other, and the whole body after parallel connection is connected with the stirrer in series, so that the link unit realizes two functions of buffering and stirring).

In conclusion, on one hand, the link unit structures the interaction and the cooperation relationship between the process units. That is, the pipeline, the buffer, the stirrer, the pressurizer, the regulator and the like are integrated together through the link unit, so that the construction of a complex system model is facilitated, and it is only required to control the functional apparatuses that need to be accessed through the apparatus access switches in the application to realize the corresponding functions, which is simple and convenient. On the other hand, the continuity, transmission and transfer of flow is realized, so that the flow information may be simulated, and the digital model constructed based on the flow information has wide application range and may better meet the actual production condition.

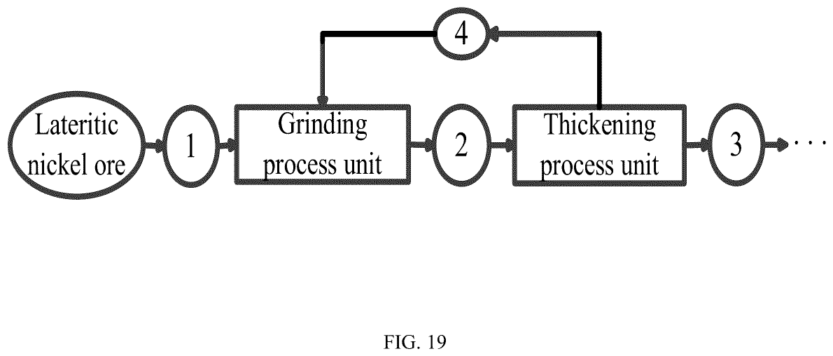

For the third, a digital model architecture is constructed according to the system process flow chart by using the process unit and the link unit. Taking low-grade laterite nickel ore hydrometallurgy as an example, as shown in FIG. 19, a partially structure schematic diagram of a digital model architecture of low-grade lateritic nickel ore hydrometallurgy is provided. Specifically, the system process flow chart is a process sequence between process units (for example, laterite nickel ore to grinding process unit to thickening process unit, wherein the laterite nickel ore is not a process unit). Because connection manners between a preorder process unit and a subsequent process unit of the link unit and between a process unit and a link unit are determined (for example, the preorder process unit of the link unit 4 is a thickening process unit, the subsequent process unit of the link unit 4 is a grinding process unit, the preorder process unit of the link unit 2 is a grinding process unit, and the subsequent process unit of the link unit 2 is a thickening process unit), the digital model architecture may be obtained by connecting all the process units to the link unit.

For the fourth, constructing a flow model and an external environment refers to constructing a flow model and an external environment on the basis of the digital model architecture. It should be noted that the flow model and the external environment are constructed for each process unit and each link unit, wherein, the constructing a flow model comprises constructing a substance flow model; constructing an energy flow model and a value flow model according to the substance flow model; and constructing an information flow model according to the substance flow model, the energy flow model and the value flow model. Wherein, the substance flow refers to substance objects processed or obtained in each process. Taking low-grade laterite nickel ore hydrometallurgy as an example, the substance flow comprises laterite nickel ore slurry and product slurry. The laterite nickel ore slurry comprises laterite nickel ore and water, and the laterite nickel ore comprises NiO and other various ore components, laterite nickel ore and other ore components, water flow and the like. Constructing a substance flow model means constructing what substance objects are at the inlets and outlets of process units and at the inlets and outlets of link units. Constructing an energy flow model is constructing internal, mechanical, and chemical energy of substance objects. Constructing a value flow model is constructing the cost incurred by the production process and the value of each substance object. Constructing an information flow model is constructing information of a production process and production control information such as temperature, pressure and the like.

Wherein an external environment is constructed. In order to realize the functions of the process unit and the link unit, the external environment is required to provide water, electricity, steam, materials and the like for the process unit and the link unit, such as temperature, humidity, water supply, heat supply, electricity supply, steam supply, acid supply and other materials, energy sources, kinetic energy supply (for example, stirring by installing a stirring paddle, and changing the flow field and flow rate of a field), and the like.

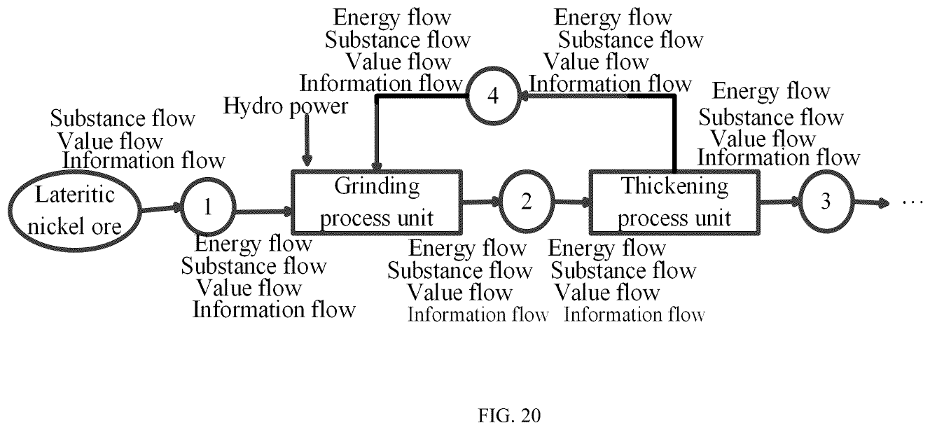

For the fifth, a digital model corresponding to the system flow is constructed according to the digital model architecture, the flow model and the external environment. Taking the low-grade laterite nickel ore hydrometallurgy as an example, as shown in FIG. 20, a partially structure schematic diagram of a digital model of low-grade laterite nickel ore hydrometallurgy is provided, wherein the process unit is represented by a block, and the link unit is represented by a circle. Specifically, the laterite nickel ore passes through the link unit 1, the link unit 1 receives flows from the laterite nickel ore, wherein the flows include substance flow, value flow and information flow. The link unit 1 has no external environment flow, outflow flows of the link unit 1 include substance flow, value flow, energy flow and information flow. Then, the flow flows into the grinding process unit, which receives, in addition to the outflow flow from link unit 1, substance flow, value flow, energy flow and information flow from link unit 4. The external environmental flow including water and electricity, the rest of which will not be repeated.

105: simulating, verifying and reconstructing the system flow through the digital model to optimize the system flow.

For this embodiment, as an implementation, the method includes: importing data to the digital model, and performing a simulated operation of the digital model, wherein the data comprises at least one of design data, test data and reference measured data; comparing actual productivity of the simulated operation with required productivity, determining whether the digital model is verified, and determining an optimization solution if the digital model is not verified; and reconstructing the digital model by using the optimization solution until the digital model is verified.

Wherein, the actual productivity of the simulated operation refers to the actual productivity of the final product obtained by putting the current system flow design into actual production. By simulating the actual productivity and then comparing it with the required productivity, it is possible to know whether the current system flow design is able to reach the capacity. Or in order to reach the capacity, a lot of resources are invested, resulting in a waste of resources, through the digital model simulation system process design, improve the production efficiency can improved, neither failure to reach the capacity, nor cause waste.

Specifically, the determining whether the digital model is verified, and determining an optimization solution if the digital model is not verified comprises: if the actual productivity is different from the required productivity and is not within a preset error range, identifying a system problem;

1. if the system problem is a system local index amplification superposition problem (that is, the local index expands input resources for reaching the capacity) or a system local bottleneck restriction problem, taking out a problem process, and reconfiguring the problem process, or taking out a problem device, and reconfiguring the problem device, to update the digital model, and performing a re-simulated operation of the digital model until the difference between the actual productivity and the required productivity is within the preset error range.

Wherein, if the system problem is a system local index amplification superposition problem, the identified problem process or problem device is the process or device with the amplified indexes, and reconfiguring the problem process or device is reducing the indexes.

Wherein, if the system problem is a system local bottleneck restriction problem, the identified problem process or problem device is the process or device with insufficient type selection, and reconfiguring the problem process or device is increasing the type selection so as to improve the index of the process or device.

2. If the system problem is the whole system productivity problem, redesigning the system flow and/or reconstructing the system structure again.

3. If the system problem is a system circuit circulating accumulation problem, reconfiguring a related process or reconstructing a local system structure.

The present disclosure provides a method, an apparatus and a device for designing a complex system flow and modeling a digital model. A system flow chart may be defined firstly, wherein the system flow chart comprises function charts and a flow sequence between the function charts; then, the system flow chart is analyzed into a plurality of processes, and the plurality of processes are formed into a system process flow chart; further, a device for realizing process functions according to the process functions and process capacities; then, a digital model corresponding to the system flow is constructed according to the device and the system process flow chart; and finally, the system flow is simulated, verified and reconstructed through the digital model to optimize the system flow. Through the technical solutions of the present disclosure, the system flow chart is analyzed into a system process flow chart including a plurality of processes, and a device for realizing each process is configured, so that the system flow design is completed. In order to determine whether the actual production productivity is matched with the required productivity after the system flow design is put into production, a digital model corresponding to the system flow is constructed according to the device and the system process flow chart, the system flow is then simulated and verified by using the digital model, so that the actual production is simulated. And when the actual productivity is not matched with the required productivity, a problem is identified to reconstruct and optimize the system flow.

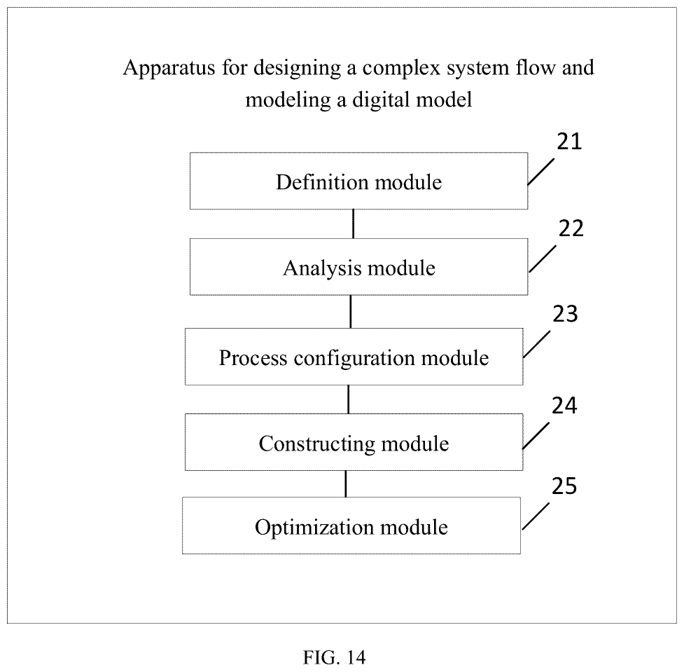

Further, as a specific implementation of the method shown in FIG. 13, an apparatus for designing a complex system flow and modeling a digital model according to an embodiment of the present disclosure is provided, and as shown in FIG. 14, the apparatus comprises a definition module 21, an analysis module 22, a process configuration module 23, a constructing module 24 and an optimization module 25;
wherein the definition module 21 is configured to define a system flow chart, where the system flow chart includes function charts and a flow sequence between the function charts;
the analysis module 22 is configured to analyze the system flow chart into a plurality of processes, and form the plurality of processes into a system process flow chart;
the process configuration module 23 is configured to configure a device for realizing process functions according to the process functions and process capacities;
the constructing module 24 is configured to construct a digital model corresponding to the system flow according to the device and the system process flow chart;
and the optimization module 25 is configured to simulate, verify and reconstruct the system flow through the digital model to optimize the system flow.

Correspondingly, in order to analyze the system flow chart into a plurality of processes and form the plurality of the processes into a system process flow chart, the analysis module 22 may be specifically configured to analyze each of the function charts into a plurality of processes and a process sequence between the processes; and form the plurality of processes into a system process flow chart according to the flow sequence and the process sequence.

Correspondingly, in order to construct a digital model corresponding to the system flow according to the device and the system process flow chart, the constructing module 24 may be specifically configured to construct the device as an agent and construct a process unit according to the agent; structure an interaction and a cooperation relationship between the process units and integrally construct a link unit; construct a digital model architecture according to the system process flow chart by using the process unit and the link unit, and construct a flow model and an external environment, wherein the external environment comprises water, electricity, steam and materials; and constructing a digital model corresponding to the system flow according to the digital model architecture, the flow model and the external environment.

Correspondingly, in order to construct the flow model, the constructing module 24 may be further specifically configured to construct a substance flow model; construct an energy flow model and a value flow model according to the substance flow model; and construct an information flow model according to the substance flow model, the energy flow model and the value flow model.

Correspondingly, in order to simulate, verify and reconstruct the system flow through the digital model, the optimization module 25 may be specifically configured to import data to the digital model, and perform a simulated operation of the digital model, wherein the data comprises at least one of design data, test data and reference measured data; compare actual productivity of the simulated operation with required productivity, determining whether the digital model is verified, and determining an optimization solution if the digital model is not verified; and reconstruct the digital model by using the optimization solution until the digital model is verified.

Correspondingly, in order to determine whether the digital model is verified, and determine an optimization solution if the digital model is not verified, the optimization module 25 may be specifically further configured to identify a system problem if the actual productivity is different from the required productivity and is not within a preset error range; if the system problem is a system local index amplification superposition problem or a system local bottleneck restriction problem, take out a problem process, and reconfigure the problem process, or take out a problem device, and reconfigure the problem device, to update the digital model, and performing a re-simulated operation of the digital model until the difference between the actual productivity and the required productivity is within the preset error range.

Correspondingly, the optimization module 25 may be specifically further configured to redesign the system flow and/or reconstruct the system structure again if the system problem is the whole system productivity problem.

It should be noted that other corresponding descriptions of the functional units related to the apparatus for designing a complex system flow and modeling a digital model provided in this embodiment may refer to the corresponding description in FIG. 13, which is not repeated herein.

Based on the method shown in FIG. 1, correspondingly, the embodiment further provides a storage medium, which may be volatile or non-volatile, and on which a computer program is stored. The computer program, when executed by a processor, is configured to implement the method for designing a complex system flow and modeling a digital model shown in FIG. 1.

Based on this understanding, the technical solution of the present disclosure may be embodied in the form of a software product. The software product may be stored in a storage medium (for example a CD-ROM, a USB flash drive, a removable hard disk, etc.), and includes several instructions for instructing a computer device (which may be a personal computer, a server, a network device, and the like) to perform the methods described in the embodiments of the present disclosure.

Based on the method shown in FIG. 13 and the virtual apparatus embodiment shown in FIG. 14, in order to achieve the above object, the present embodiment further provides a computer device. The computer device includes a storage medium and a processor. The storage medium is configured to store a computer program. And the processor is configured to execute the computer program to implement the method for designing a complex system flow and modeling a digital model shown in FIG. 1.

Optionally, the computer device may further comprise a user interface, a network interface, a camera, a radio frequency (RF) circuit, a sensor, an audio circuit, a WI-FI module, and the like. The user interface may include a display, an input unit such as a keyboard and the like, and an optional user interface may also include a USB interface, a card reading interface and the like. The network interface may optionally include a standard wired interface, a wireless interface (such as a WI-FI interface), and the like.

Those skilled in the art should understand that the structure of the computer device according on the embodiment does not constitute a limitation on the entity device. On the contrary, the computer device may include more or less components. Some components may be combined or components may be arranged differently.

The storage medium may also include an operating system and a network communication module. The operating system is a program that manages the hardware and software resources of the computer device described above, and supports operations of the information processing program and other software and/or programs. The network communication module is configured to realize communication between the components in the storage medium and communication with other hardware and software in the information processing entity device.

Through the descriptions of the foregoing embodiments, those skilled in the art can clearly understand that the present disclosure may be implemented by means of software and an general hardware platform, and also may be implemented by hardware.

The present disclosure provides a method, an apparatus and a device for designing a complex system flow and modeling a digital model. A system flow chart may be defined firstly, wherein the system flow chart comprises function charts and a flow sequence between the function charts; then, the system flow chart is analyzed into a plurality of processes, and the plurality of processes are form into a system process flow chart; further, a device for realizing process functions according to the process functions and process capacities; then, a digital model corresponding to the system flow is constructed according to the device and the system process flow chart; and finally, the system flow is simulated, verified and reconstructed through the digital model to optimize the system flow. Through the technical solutions of the present disclosure, the system flow chart is analyzed into a system process flow chart including a plurality of processes, and a device for realizing each process is configured, so that the system flow design is completed. In order to determine whether the actual productivity is matched with the required productivity after the system flow design is put into production, a digital model corresponding to the system flow is constructed according to the device and the system process flow chart, the system flow is then simulated and verified by using the digital model, so that the actual production is simulated. And when the actual productivity is not matched with the required productivity, a problem is identified to reconstruct and optimize the system flow.

The foregoing descriptions are only preferred embodiments of the present disclosure. With the foregoing teachings of the present disclosure, a person skilled in the art may make other improvements or deformations based on the foregoing embodiments. It should be understood by those skilled in the art that the foregoing detailed description is only for the purpose of better describing the present disclosure, and the protection scope of the present disclosure shall be subject to the protection scope of the claims.

What is claimed is:

1. A method for modeling a digital model of a production system, comprising:
dividing a process flow of the production system according to the process to obtain a plurality of process units to be constructed;
determining a process relationship between the process units, and constructing a digital model architecture, a flow model and an environment model; and
constructing a digital model corresponding to the system flow according to the digital model architecture, the flow model and the external environment.

2. The method according to claim 1, wherein the determining a process relationship between the process units, and constructing a digital model architecture, a flow model and an environment model comprises:
constructing a device group model corresponding to each process unit respectively, wherein the device group model comprises at least one agent, and the agents are connected in series or in parallel with each other;
constructing a flow model corresponding to each process unit respectively, wherein the flow model configures obtained flow data for the process unit, and the flow data comprises inlet flow data and/or outlet flow data, and the data types in the flow data at least comprise one or more of substance flow data, energy flow data, value flow data and information flow data; and
constructing an environment model corresponding to each process unit respectively, wherein the environment model configures obtained environment data for the process unit, and the data types of the environment data comprise one or more of water supply data, heat supply data, electricity supply data, steam supply data, material data, energy data and kinetic energy supply data.

3. The method according to claim 2, wherein before constructing the digital model, the method further comprises:
according to the function of the process unit to be constructed, determining a plurality of chemical reaction equations for realizing the function, and constructing a reaction set model corresponding to each process unit;
constructing a process unit field model, wherein the process unit field model is reaction parameter information for realizing the chemical reaction equations in the reaction set, and the reaction parameter information includes one or more of storage volume information, temperature information, pressure information, pH information, substance information, concentration information, viscosity information, flow field rate information and gradient information.

4. The method according to claim 3, wherein before constructing the digital model, the method further comprises:
analyzing the reaction parameter information by applying a preset factor analysis method, and determining target reaction parameter information and a value range corresponding to the target reaction parameter information;
constructing a system state function corresponding to the current process unit by taking the target reaction parameter information as a system state variable;
determining a plurality of parameter values corresponding to each system state variable respectively in each value range; and
matching the parameter values to construct a system state set model meeting a preset design requirement.

5. The method according to claim 2, wherein before constructing the digital model, the method further comprises:
constructing a process unit fault set model, wherein the process unit fault set model configures fault information of each functional device and each pipeline for the process unit, wherein the fault information comprises the fault type and maintenance information corresponding to the fault type;
the maintenance information comprises: one or more of shutdown frequency information, distribution pattern information and maintenance time information.

6. The method according to claim 3, wherein before constructing the digital model, the method further comprises:
constructing a process unit clock model, wherein the process unit clock model configures time domain information and tempo time information for the process unit;
the time domain information is the time experienced by each flow data from the starting point of entering the process unit to the end point of exiting the process unit;
the tempo time information is duration corresponding to a basic action in a chemical reaction process for realizing the function, wherein the basic action comprise one or more of a predetermined amount of chemical reaction, a predetermined amount of separation of substance flow, leaching of a predetermined amount of substance flow.

7. The method according to claim 1, wherein the determining a process relationship between the process units comprises:
defining a system flow chart, wherein the system flow chart comprises function charts and a flow sequence between the function charts;
analyzing the system flow chart into a plurality of processes and forming the plurality of processes into a system process flow chart;
configuring a device for realizing process functions according to the process functions and process capacities; and
constructing the device as an agent, and constructing a process unit according to the agent, and determining a process relationship of the process unit.

8. The method according to claim 7, wherein after constructing the digital model, further comprising:
simulating, verifying and reconstructing the system flow through the digital model to optimize the system flow.

9. The method according to claim 7, wherein the analyzing the system flow chart into a plurality of processes and forming the plurality of processes into a system process flow chart comprises:
analyzing each function chart into a plurality of processes and a process sequence between the processes; and
forming the plurality of the processes into a system process flow chart according to the flow sequence and the process sequence.

10. The method according to claim 7, wherein the constructing a digital model architecture, a flow model and an environment model comprises:
structuring an interaction and a cooperation relationship between the process units and integrally constructing a link unit;
constructing a digital model architecture according to the system process flow chart by using the process unit and the link unit, and constructing a flow model and an external environment, wherein the external environment comprises water, electricity, steam and materials; and
constructing a digital model corresponding to the system flow according to the digital model architecture, the flow model and the external environment.

11. The method according to claim 10, wherein the constructing a flow model comprises:
constructing a substance flow model;
constructing an energy flow model and a value flow model according to the substance flow model; and
constructing an information flow model according to the substance flow model, the energy flow model and the value flow model.

12. The method according to claim 8, wherein the simulating, verifying and reconstructing the system flow through the digital model comprises:
importing data to the digital model, and performing a simulated operation of the digital model, wherein the data comprises at least one of design data, test data and reference measured data;
comparing actual productivity of the simulated operation with required productivity, determining whether the digital model is verified, and determining an optimization solution if the digital model is not verified; and
reconstructing the digital model by using the optimization solution until the digital model is verified.

13. The method according to claim 12, wherein the determining whether the digital model is verified, and determining an optimization solution if the digital model is not verified comprises:
if the actual productivity is different from the required productivity and is not within a preset error range, identifying a system problem;
if the system problem is a system local index amplification superposition problem or a system local bottleneck restriction problem, taking out a problem process, and reconfiguring the problem process, or taking out a problem device, and reconfiguring the problem device, to update the digital model, and performing a re-simulated operation of the digital model until the difference between the actual productivity and the required productivity is within the preset error range.

14. The method according to claim 13, wherein further comprising:
if the system problem is the whole system productivity problem, redesigning the system flow and/or reconstructing the system structure again.

15. An apparatus for modeling a digital model of a production system, comprising:
a process unit constructing unit, configured to divide a process flow of the production system according to the process to obtain a plurality of process units to be constructed;
a model preliminary constructing unit, configured to determine a process relationship between the process units, and constructing a digital model architecture, a flow model and an environment model; and
a digital model constructing unit, configured to construct a digital model corresponding to the system flow according to the digital model architecture, the flow model and the external environment.

16. The apparatus according to claim 15, wherein the model preliminary constructing unit comprises:
a device group model constructing module, configured to construct a device group model corresponding to each process unit respectively, where the device group model includes at least one agent, and the agents are connected in series or in parallel with each other;
a flow model constructing module, configured to construct a flow model corresponding to each process unit respectively, wherein the flow model configures obtained flow data for the process unit, and the flow data comprises inlet flow data and/or outlet flow data, and the data types in the flow data at least comprise one or more of substance flow data, energy flow data, value flow data and information flow data; and
an environment model constructing module, configured to construct an environment model corresponding to each process unit respectively, wherein the environment model configures obtained environment data for the process unit, and the data types of the environment data comprise one or more of water supply data, heat supply data, electricity supply data, steam supply data, material data, energy data and kinetic energy supply data.

17. The apparatus according to claim 15, wherein the model preliminary constructing unit comprises:
a system flow definition module, configured to define a system flow chart, wherein the system flow chart comprises function charts and a flow sequence between the function charts;
a process flow chart determining module, configured to analyze the system flow chart into a plurality of processes and form the plurality of processes into a system process flow chart;
a device configuration module, configured to configure a device for realizing process functions according to the process functions and process capacities; and
a process unit determining module, configured to construct the device as an agent, construct a process unit according to the agent and determine a process relationship of the process unit.

18. The apparatus according to claim 17, further comprising:
a model optimization unit, configured to simulate, verify and reconstruct the system flow through the digital model to optimize the system flow.

19. The apparatus according to claim 17, wherein the process flow chart determining module is specifically configured to analyze each function chart into a plurality of processes and a process sequence between the processes, and form the plurality of the processes into a system process flow chart according to the flow sequence and the process sequence.

20. The apparatus according to claim 17, wherein the model preliminary constructing unit comprises:
a link unit integration module, configured to structure an interaction and a cooperation relationship between the process units and integrally construct a link unit;
a model preliminary constructing module, configured to construct a digital model architecture according to the system process flow chart by using the process unit and the link unit, and construct a flow model and an external environment, wherein the external environment comprises water, electricity, steam and materials; and
a digital model constructing module, configured to construct a digital model corresponding to the system flow according to the digital model architecture, the flow model and the external environment.
